(19) United States
(12) Patent Application Publication
(10) Pub. No.: US 2025/0192887 A1
(43) Pub. Date: Jun. 12, 2025

(54) UNDERWATER EQUIPMENT AND COMMUNICATION SYSTEM

(71) Applicant: HMN Technologies Co., Limited, Tianjin (CN)

(72) Inventors: Hongbo Sun, Tianjin (CN); Hongxi Nie, Tianjin (CN); Mao Zhao, Tianjin (CN)

(21) Appl. No.: 18/889,435

(22) Filed: Sep. 19, 2024

(30) Foreign Application Priority Data
Dec. 6, 2023 (CN) 202311656840.9

(51) Int. Cl. H04B 10/25; H01S 3/067; H04B 10/50; H04B 10/564

(52) U.S. Cl. CPC H04B 10/25; H01S 3/06754; H04B 10/503; H04B 10/564

(57) ABSTRACT

An underwater equipment and a communication system are provided. The underwater equipment includes an optical fiber, a conventional pump laser configured to provide pump light to an optical amplification unit and a backup pump laser configured to, when output power of the conventional pump laser is less than a target output power, perform output power compensation, and to perform output power compensation when aging value of the underwater equipment is greater than a first threshold value or aging value of a connected line or optical device thereof is greater than a second threshold value. By providing the underwater equipment with backup pump laser, pump output power of the underwater equipment can be compensated by starting the backup pump laser when the conventional pump laser is aging, or compensation is performed when the submarine cable optical fiber and other optical device of the underwater fiber communication system are aging.

### CROSS-REFERENCE TO RELATED APPLICATION

This application claims priority to Chinese Patent Application No. 2023116568409, filed on Dec. 6, 2023, which is incorporated herein by reference in its entirety.

### FIELD OF THE INVENTION

This application relates to the field of optical communication technology, and in particular to an underwater equipment and a communication system.

### BACKGROUND OF THE INVENTION

The submarine cable communication system, as an important means for international communication, is usually desired to provide service for 25 years. However, in practice, the submarine cable communication system faces a challenge of system performance deterioration caused by device aging in the middle and late service life span. The optical repeater of the submarine cable communication system mainly adopts an optical amplification technology of Erbium Doped Fiber Amplifier (EDFA). For the communication system including optical fiber amplifiers, aging of a pump laser is one of main sources leading to performance deterioration of the submarine cable communication system.

In the middle and late service life span of the submarine cable communication system, the output power of the optical repeater decreases due to the aging of the pump laser, making losses caused by aging of other optical devices and aging of optical fiber lines further increased, the optical signal noise ratio (OSNR) performance of the lines deteriorates, and even service interruption occurs.

When the submarine cable communication system is aging, the submarine cable communication system should be constructed and maintained, and additional optical repeater may be added to the line to increase the optical power of the line and thus mitigate the deterioration of system performance caused by the aging. However, in the maintenance process, the construction vessel has to cut the submarine cable for maintenance, and thus the business of the whole system will be interrupted due to long maintenance time. In addition, the later maintenance cost is also high.

### SUMMARY OF THE INVENTION

An underwater equipment and a communication system are provided according to the present application, to solve the problem that output power of the pump laser cannot meet the output requirements due to performance deterioration of the pump laser in the submarine cable communication system, or that loss increases due to aging of submarine cable optical fiber and other optical device of the submarine cable communication system, thus causing the service life of the submarine cable communication system cannot up to standard.

In a first aspect, an underwater equipment is provided according to some embodiments of the present application. The underwater equipment includes an optical fiber, a conventional pump laser and a backup pump laser.

The conventional pump laser is configured to provide pump light to an optical amplification unit located at the optical fiber;

The conventional pump laser and the backup pump laser are coupled to an input port of an optical device of the optical fiber, and an output port of the optical device is coupled to the optical fiber;

The backup pump laser is configured to, when an output power of the conventional pump laser is less than a target output power, perform output power compensation, wherein a compensated output power is greater than or equal to an output power lost by the conventional pump laser in an aging state, and the backup pump laser is further configured to, when an aging value of the underwater equipment is greater than a first threshold value or when an aging value of a line connected to the underwater equipment or an optical device of the underwater equipment is greater than a second threshold value, perform output power compensation;

The backup pump laser is configured to be in a closed state before receiving a first instruction, and to start and output pump light upon receiving the first instruction, wherein the first instruction is a control instruction that is sent when the output power of the conventional pump laser is less than the target output power;

The backup pump laser is further configured to be in the closed state before receiving a second instruction, and to start and output pump light upon receiving the second instruction, wherein the second instruction is a control instruction that is sent when the aging value of the underwater equipment is greater than the first threshold value, or the second instruction is a control instruction that is sent when the aging value of the line connected to the underwater equipment or the optical device of the underwater equipment is greater than the second threshold value, wherein the aging value of the underwater equipment is obtained based on a bit error rate, an optical signal noise ratio and a coherent optical time domain reflection detection of the underwater equipment. According to the present application, by providing the underwater equipment with at least one backup pump laser, pump output power of the underwater equipment can be compensated by starting the backup pump laser when the conventional pump laser is aging, and thus the service life of the submarine cable communication system is improved.

The underwater equipment can compare the calculated aging value with the threshold value, and start the backup pump laser when the aging value of the underwater equipment and/or the line connected to the underwater equipment or the optical device of the underwater equipment is greater than the threshold value, to reduce the losses of the underwater equipment or the underwater fiber communication system.

According to some embodiments of the present application, a quantity of the backup pump laser is greater than or equal to 1, and is less than or equal to n, where n equals to a quantity of the conventional pump lasers.

According to some embodiments of the application, the conventional pump laser includes a first pump laser and a second pump laser; the second pump laser and the backup pump laser are coupled to the input port of the optical device of the optical fiber, and the output port of the optical device is coupled to the optical fiber;

The first pump laser is coupled to the optical fiber through an optical fiber coupler; an input port of the optical fiber coupler is connected with the output port of the optical device and the first pump laser, and an output port of the optical fiber coupler is connected with the optical amplification unit. A quantity of backup pump lasers may be provided for a certain proportion of conventional pump lasers after evaluating device reliability and system performance. The cost can be reduced by periodically setting the backup pump lasers and selectively starting some of the backup pump lasers.

According to some embodiments of the application, the underwater equipment includes at least one first pump laser and one second pump laser, each of the first pump lasers provides 50% of energy for the optical amplification unit, and each of the second pump lasers provides 50% of energy for the optical amplification unit; or
the underwater equipment includes: at least three first pump lasers; and one second pump laser, each of the first pump lasers provides 25% of energy for the optical amplification unit, and the second pump laser provides 25% of energy for the optical amplification unit. The underwater equipment is provided with a redundant pump optical path, and two paths of the conventional pump lasers are redundant to each other, in case that one conventional pump laser fails, the other conventional pump laser provides pump light, meanwhile, the backup pump laser in the 2×2 or 4×4 redundant pump optical path of single optical fiber pair is started, thereby increasing pump power of all EDFA lines through the 2×2 or 4×4 redundant pump optical path.

According to some embodiments of the present application, the conventional pump lasers of the underwater equipment contains only one second pump laser that is connected with the backup pump laser. The newly added backup pump laser is not only used to compensate the pump power reduced due to the aging, but also to provide additional pump power in case of aging caused by the losses of the submarine cable and other component in the underwater fiber communication system, and only one of the conventional pump lasers of the underwater equipment is connected with the backup pump laser. In this way, pump output power compensation is achieved while reducing costs.

According to some embodiments of the present application, the optical device is a polarization beam combiner or an optical switch. The conventional pump laser and the backup pump laser can be optically coupled by the polarization beam combiner, and the conventional pump laser and/or the backup pump laser may be selectively on or off via the optical switch.

According to some embodiments of the present application, each conventional pump laser is provided with a backup pump laser, and the conventional pump laser and the backup pump laser are coupled via a polarization beam combiner or an optical switch. With all the conventional pump lasers of the underwater equipment throughout the lines being provided with backup pump lasers, the range and granularity for adjusting performance of the entire underwater fiber communication system are improved.

According to some embodiments of the present application, the underwater equipment is an optical repeater. The optical repeater is additionally provided with a backup pump laser to compensate the decrease in the output power of the conventional pump laser due to aging and improve the aging condition of the pump laser, the output power of the optical repeater meets the working requirements, the optical signal noise ratio of the optical repeater is kept stable and the transmission performance is kept stable. The addition of the backup pump laser can also provide additional pump power in case of aging caused by losses of the line connected to the underwater equipment or the underwater fiber communication system.

In a second aspect, an underwater fiber communication system is provided according to some embodiments of the present application, which includes a first station, a second station and the underwater equipment according to the first aspect, wherein the underwater equipment is coupled to an uplink between the first station and the second station, and/or the underwater equipment is coupled to a downlink between the first station and the second station;

The first station is configured to send a first data optical signal to the optical fiber of the underwater equipment coupled to the uplink; and the underwater equipment coupled to the uplink is configured to amplify the first data optical signal and send the amplified first data optical signal to the second station; or

The second station is configured to send a second data optical signal to the optical fiber of the underwater equipment coupled to the downlink, and the underwater equipment coupled to the downlink is configured to amplify the second data optical signal and send the amplified second data optical signal to the first station;

The first station and/or the second station determine whether a system aging occurs according to change in an optical signal noise ratio of a service optical signal at a receiving end; the first station and/or the second station predict a system aging trend by monitoring a change trend of the optical signal noise ratio in real time or periodically detecting and comparing change in the optical signal noise ratio.

According to some embodiments of the present application, the underwater fiber communication system determines an aging degree of the underwater fiber communication system based on detecting in real time a bit error rate of a system service performance or monitoring data of a terminal station OTDR/COTDR.

From the above technical solutions, an underwater equipment and a communication system are provided according to some embodiments of the present application. The underwater equipment includes an optical fiber, a conventional pump laser and a backup pump laser. The conventional pump laser is configured to provide pump lights to an optical amplification unit located at the optical fiber. The backup pump laser is configured to perform output power compensation when an output power of the conventional pump laser is less than a target output power, and the backup pump laser is further configured to perform output power compensation when an aging value of the underwater equipment is greater than a first threshold value or when an aging value of a line connected to the underwater equipment or an optical device of the underwater equipment is greater than a second threshold value. According to the present application, by providing the underwater equipment with a backup pump laser, pump output power of the underwater equipment may be compensated by starting the backup pump laser when the conventional pump laser is aging, or output power compensation is performed when an aging value of the underwater equipment is greater than a first threshold value or when an aging value of a line connected to the underwater equipment or an optical device of the underwater equipment is greater than a second threshold value, and thus the service life of the submarine cable communication system is improved.

### BRIEF DESCRIPTION OF THE DRAWINGS

In order to illustrate the technical solutions of the present application in details, a brief description of the drawings used for embodiments is given below. It is to be noted that other drawings may be obtained from these drawings for those skilled in the art without making creative efforts.

FIG. 1 is a structural schematic diagram of an underwater fiber communication system.

FIG. 2 is a first structural schematic diagram of an underwater equipment according to some embodiments of the present application.

FIG. 3 is a second structural schematic diagram of an underwater equipment according to some embodiments of the present application.

FIG. 4 is a third structural schematic diagram of an underwater equipment according to some embodiments of the present application.

FIG. 5 is a structural schematic diagram of a communication system of an underwater equipment according to some embodiments of the present application.

### DESCRIPTION FOR THE DRAWINGS

100—underwater equipment; 101—conventional pump laser; 102—backup pump laser; 110—optical fiber on uplink; 120—optical fiber on downlink; 130—optical device; 140—optical fiber coupler; 150—first optical amplification unit; 160—second optical amplification unit; 200—first station; 300—second station.

### DETAILED DESCRIPTION OF THE EMBODIMENTS

The technical solutions of the present application will be clearly described in combination with embodiments below in details. Obviously, the embodiments described herein are only part, but not all, of embodiments of this disclosure. All other embodiments that may be obtained by those skilled in the art based on the embodiments of the present application without creative labor fall within the protection scope of the present application.

The terms “first” and “second” are used for descriptive purposes only and are not to be understood as indicating or implying importance or as implicitly indicating the quantity of technical features indicated. Thus, a feature defined with a “first” or “second” may explicitly or implicitly includes one or more of said features. In the description of the present application, “multiple” or “a plurality of” means two or more, unless otherwise expressly specified. In addition, the terms “mounting”, “connect” and “connection” should be understood in a broad sense, for example, it may indicate a fixed connection, a detachable connection or an integrated connection; or it may indicate a mechanical connection or an electrical connection; or it may be directly connected or indirectly connected through an intermediate medium; or it may indicate communication within two elements. For those skilled in the art, the specific meaning of the above terms in the present application may be understood based on specific context.

The underwater fiber communication system is generally laid at the seabed or the bottom of the lake, to achieve a long-distance data communication. For example, the underwater fiber communication system may include a submarine cable communication system.

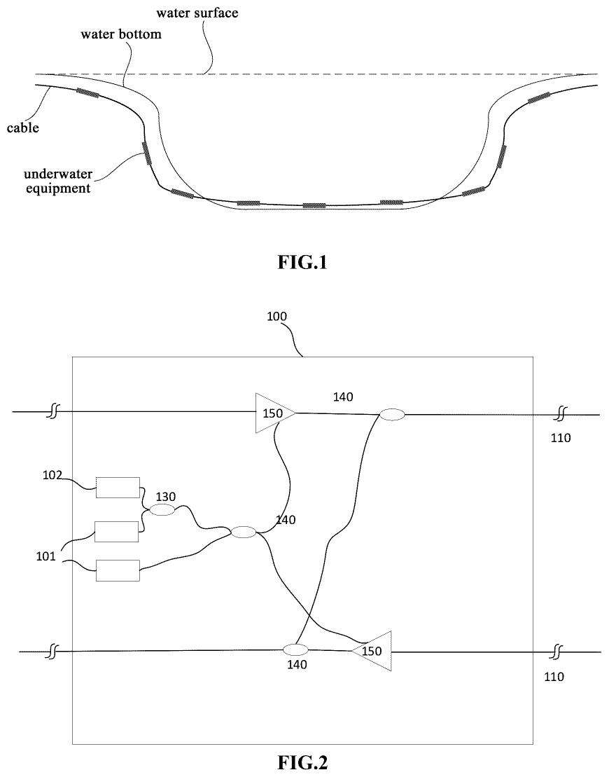

As shown in FIG. 1, the submarine cable communication system, as an important means for international communication, is usually required to provide service for 25 years. However, in practice, the submarine cable communication system faces a challenge of system performance deterioration due to device aging in the middle and late service life span. The optical repeater of the submarine cable communication system mainly adopts an optical amplification technology of Erbium Doped Fiber Amplifier (EDFA). For a communication system including an optical fiber amplifier, aging of a pump laser is one of main reasons leading to performance deterioration of the submarine cable communication system.

In the middle and late service life span of the submarine cable communication system, the output power of the optical repeater decreases due to the aging of the pump laser, making losses caused by aging of other optical devices and aging of optical fiber lines further increased, the optical signal noise ratio (OSNR) performance of the lines deteriorates, and even service interruption occurs.

In the related technology, a significant derating design is made for the pump laser to suppress aging of the pump device, so as to extend the service life of the communication system through submarine cable and optical fiber. However, the output current and output power of the pump laser are limited, the performance of the device itself cannot be fully utilized, resulting in a waste of device performance, and the system even cannot work at the best performance point in serious cases.

In the related technology, in case that the pump laser is aging, the submarine cable communication system may be constructed and maintained, and additional optical repeater may be added to the line to increase the optical power of the line and mitigate deterioration of system performance caused by the aging. However, in the maintenance process, the construction vessel has to cut the submarine cable for maintenance, and thus the business of the whole system would be interrupted, long maintenance time is needed, and later maintenance cost is also high.

In order to solve the problem that the output power of the pump laser cannot meet the output requirements due to deterioration of performance of the pump laser in the submarine cable communication system, or that the service life of the submarine cable communication system cannot meet the relevant standard due to loss increasing caused by aging of submarine cable optical fiber and other optical device of the submarine cable communication system, an underwater equipment is provided according to some embodiments of the present application. By providing the underwater equipment with a backup pump laser, the backup pump laser may be started to compensate the pump output power of the underwater equipment when the conventional pump laser is aging, or the pump laser may compensate the pump power when the submarine cable optical fiber and other optical device of the underwater fiber communication system are aging, and thus the service life of the submarine cable communication system is improved.

An underwater equipment 100 is provided according to some embodiments of the present application. The underwater equipment 100 includes an optical fiber 110, a conventional pump laser 101 and a backup pump laser 102.

The conventional pump laser 101 is configured to provide pump lights to an optical amplification unit located at the optical fiber 110.

The conventional pump laser 101 and the backup pump laser 102 are coupled to an input port of an optical device 130 of the optical fiber 110, and an output port of the optical device 130 is coupled to the optical fiber 110,

The backup pump laser 102 is configured to, when an output power of the conventional pump laser 101 is less than a target output power, perform output power compensation. An output power compensated by the backup pump laser is greater than or equals to an output power lost by the conventional pump laser 101 in an aging state. It should be noted that the conventional pump laser 101 works normally during the service process of the communication system, while the backup pump laser 102 does not work at the initial stage of the service process of the communication system, and is started upon receiving a control instruction sent by the underwater equipment 100 or is started based on a start instruction sent by a ground base station.

The backup pump laser 102 is further configured to, when an aging value of the underwater equipment is greater than a first threshold value or when an aging value of a line connected to the underwater equipment or of an optical device of the underwater equipment is greater than a second threshold value, perform output power compensation.

In some embodiments, the backup pump laser 102 is configured to be in a closed state before receiving a first instruction, and to start and output pump light upon receiving the first instruction. The first instruction is a control instruction that is sent when the output power of the conventional pump laser 101 is less than the target output power. The underwater equipment 100 can detect the output power of the conventional pump laser 101 or the underwater equipment 100 in real time, and start the backup pump laser 102 when the output power is less than the target output power. In practical applications, in order to solve the problem that service life of the underwater equipment cannot meet the relevant standard, the compensation power outputted by the backup pump laser is higher than the output power lost by the conventional pumped laser due to aging, and the compensated output power is greater than or equal to the output power lost by the conventional pumped laser in the aging state.

In some embodiments, the backup pump laser 102 is further configured to be in the closed state before receiving a second instruction, and to start and output pump light upon receiving the second instruction. The second instruction is a control instruction that is sent when an aging value of the underwater equipment is greater than a first threshold value, or the second instruction is a control instruction that is sent when the aging value of the line connected to the underwater equipment or the optical device of the underwater equipment is greater than a second threshold value. The aging value of the underwater equipment is obtained based on a bit error rate, an optical signal noise ratio and a coherent optical time domain reflection detection of the underwater fiber communication system. The priority of the first instruction and the priority of the second instruction may be the same or different, or it is not necessary to distinguish the priority between the first instruction and the second instruction.

The aging value of the underwater equipment 100 may be obtained based on a bit error rate or an optical signal noise ratio of the underwater fiber communication system, or a loopback signal power of the underwater equipment 100.

It should be noted that the bit error rate is also called as an error rate. An electrical signal is converted into an optical signal, which is transmitted in a WDM wavelength division system and reaches an end of a link, and then is converted into an electrical signal by a receiver, and during this process, the ratio of the number of error bits to the number of total bits is the bit error rate. The bit error rate is an ultimate value to measure transmission quality. In some embodiments, the underwater fiber communication system detects the bit error rate of the service performance of the system in real time, and if the bit error rate of the service performance of the system becomes larger, the aging degree of the system becomes greater.

It should be noted that the optical signal noise ratio (OSNR) refers to a ratio of an optical signal power to a noise power when an optical effective bandwidth is within 0.1 nm. In some embodiments, a ground end station may determine whether a system is aging based on a change of an optical signal noise ratio of optical signal at a receiving end. By monitoring changing tendency of the OSNR in real time or periodically testing and comparing changes of the OSNR, aging tendency of the system may be predicted.

In some embodiments, changes in a gain of an optical repeater (RPT) may be visually detected with an OTDR (optical time domain reflection) device or a COTDR (coherent optical time domain reflection) device provided at the ground end station, and it is possible to determine whether the pump laser is aging based on the change of the gain of the RPT. The test principle of OTDR (optical time domain reflection) is to add pulse modulation to the laser, and send a test light to an optical transmission line of a measurement object through an optical direction coupler that can separate an emitted light and a received light. Because of the function of rayleigh scattering, backscattered lights returned from various aspects of the optical fiber (including non-uniformity of the optical fiber, the optical connector, the optical fiber splice, the fault or breakpoint of the optical fiber) will be represented as a continuous signal on the time base of the screen, that is, first near and then far, and its intensity is proportional to the power of the transmitted light at each point. Obviously, the backscattered light is separated by the optical coupler and then is received, the horizontal axis is in the form of distance, corresponding to the order of arrival times of the backscattered lights, and the vertical axis represents the intensities of the scattered lights in the unit of dB, which are displayed on the screen. The round-trip time of the optical pulse may be converted into the scale of the optical fiber length on the horizontal axis, which may be used to directly observe the changing state of the power of the transmitted light along the entire fiber line.

It should be noted that the COTDR (coherent optical time domain reflection) technology is a method of monitoring the underwater portion of the submarine cable communication system. Specifically, a detection optical pulse signal is sent into the optical fiber, and backward rayleigh scattered light will be continuously generated along the optical fiber when the optical pulse is transmitted in the optical fiber. Reflections will occur at the connector, mechanical connected or broken points or optical fiber terminations. Some of the backward rayleigh scattered light and reflected light will be transmitted back to the emission end along the optical fiber and received by the detector of the COTDR device. The working states of the submarine cable and the repeater can be determined from the change of the intensity of the received optical pulse.

In some embodiments, output ports of the optical amplification units of the underwater equipment 100 are respectively connected with an optical fiber coupler 140. The optical fiber coupler 140 includes a first optical fiber coupler located at the optical fiber 110 on uplink and a second optical fiber coupler located at the optical fiber 120 on downlink. The first optical fiber coupler located at the optical fiber 110 on uplink is configured to receive a first reflected optical signal and send a part of the first reflected optical signal to the second optical fiber coupler located at the optical fiber 120 on downlink. The first reflected optical signal is obtained from the amplified first detection optical signal after backward rayleigh scattered. The second optical fiber coupler located at the optical fiber 120 on downlink is configured to receive the part of the first reflected optical signal outputted from the first optical fiber coupler and send the part of the first reflected optical signal towards the first station 200. Adding the optical fiber coupler 140 to the output port of the optical amplification unit of the underwater equipment 100 will not cause deterioration of the noise coefficient of the underwater equipment 100. By coupling between each pair of optical fibers in the underwater equipment 100, that is, setting a loopback path, the backward rayleigh scattered optical signal and/or reflected optical signal of the detection optical signal incident in the uplink can be coupled into the downlink, transmitted along the downlink optical fiber and then amplified by the downlink optical amplification unit when passing through the underwater equipment 100. In this way, the detection optical signal can be reversely transmitted back to the ground end station. Therefore, it is easier for the detector of the COTDR device to receive the detection optical signal. In this way, aging or failure of the conventional pump laser can be detected by the COTDR device, and the backup pump laser can be started in time to make the backup pump laser output pump light to compensate the pump output power of the underwater equipment 100. Or, the COTDR device can detect the aging of the submarine cable optical fiber or other optical device of the underwater fiber communication system, and the backup pump laser is timely started to compensate the line losses caused by the aging of the submarine cables and the RPT output power losses caused by the aging of other optical device.

The optical fibers in this embodiment may belong to the same optical fiber pair or to different optical fiber pairs. That is, the optical fiber on uplink and the optical fiber on downlink are different, and the optical fiber on uplink is the first optical fiber, and the optical fiber on downlink is the second optical fiber. In some embodiments, the first optical fiber may be used to send an optical signal to the land base station at the opposite end, and the second optical fiber may be used to receive an optical signal sent from the land base station at the opposite end.

By taking a loopback path constructed by uplink and downlink as an example, the optical amplification unit in this application includes a first optical amplification unit 150 arranged on the uplink and a second optical amplification unit 160 arranged on the downlink, and a detection method of detecting a submarine cable line with the COTDR (coherent optical time domain reflection) device may be as follows.

A submarine cable line detection device sends out a detection signal, and the detection signal inputted into the first optical amplification unit 150 is divided into a first detection signal and a second detection signal. The two detection signals pass through different paths to detect conditions of the optical amplification unit and the optical cable line connecting to the optical amplification unit.

The first detection signal, obtained after splitting, is directly coupled to and loopbacked to the output port of the second optical amplification unit 160 in a different direction from the first optical amplification unit 150, forming a first loopback path, and a first detection loopback signal is output and returned to the optical cable line. The first detection signal obtained after splitting is directly coupled and loopbacked to the output port of the second optical amplification unit 160, forming the first loopback path, and the first detection loopback signal is output in an uplink or downlink trunk. The first detection loopback signal is a direct coupling loopback signal, and the output first detection loopback signal is measured to obtain a power of the first detection loopback signal. The direction of the second optical amplification unit 160 is different from the direction of the first optical amplification unit 150. For example, the first optical amplification unit 150 is used for downlink transmission and the second optical amplification unit 160 is used for uplink transmission during downlink detection. When the first optical amplification unit 150 is a downlink optical amplification unit, the condition of the downlink submarine cable line may be detected based on the power of the first detection loopback signal and the power of the second detection loopback signal. When the first optical amplification unit 150 is an uplink optical amplification unit, the condition of the uplink submarine cable line may be detected based on the power of the first detection loopback signal and the power of the second detection loopback signal.

The second detection signal passes through the first optical amplification unit 150 and then is loopbacked to the output port of the second optical amplification unit 160, forming a second loopback path, and a second detection loopback signal is output. The second detection signal enters into the optical cable line through the first optical amplification unit 150. The second detection signal is loopbacked to the output port of the second optical amplification unit 160 after passing through the first optical amplification unit 150, forming the second loopback path, and the second detection loopback signal is output in the uplink or downlink trunk. The second detection loopback signal is measured to obtain a power of the second detection loopback signal. The detection device sends a pulse light. The first detection loopback signal is a pulse signal, and the power of the second detection loopback signal is determined based on the return time and pulse width.

The condition of the submarine cable line is detected based on the power of the first detection loopback signal and the power of the second detection loopback signal.

In some embodiments, the number of the backup pump lasers is greater than or equal to 1, and is less than or equal to n, where n is the number of the conventional pump lasers. For example, each conventional pump laser 101 may be connected with a backup pump laser 102; or only one conventional pump laser 101 is connected with a backup pump laser 102 (the entire underwater equipment includes only one backup pump laser 102). The backup pump laser 102 may be provided for a certain proportion of the conventional pump lasers based on actual requirements.

It should be noted that the number of the backup pump lasers 102 of the underwater equipment 100 may be chosen to be a certain proportion of the conventional pump lasers 101 after evaluation of device reliability and system performance. In some embodiments, the underwater equipment 100 includes multiple conventional pump lasers 101 including a first pump laser and a second pump laser connected with the backup pump laser 102.

The second pump laser and the backup pump laser are coupled to the input port of the optical device of the optical fiber, and the output port of the optical device is coupled to the optical fiber.

The first pump laser is coupled to the optical fiber through an optical fiber coupler; an input port of the optical fiber coupler is connected with the output port of the optical device and the first pump laser, and an output port of the optical fiber coupler is connected with the optical amplification unit.

It should be noted that in this embodiment, the conventional pump laser that is connected with a backup pump laser 102 is the second pump laser, and the conventional pump laser not connected with a backup pump laser 102 is the first pump laser, and the number of the second pump lasers is the same as the number of the backup pump lasers. The number of the second pump laser is greater than or equal to 1, and is less than or equal to the number of the first pump laser.

In some embodiments, the underwater equipment 100 includes at least one first pump laser and one second pump laser, each of the first pump lasers provides 50% of energy for the optical amplification unit 150, and each of the second pump lasers provides 50% of energy for the optical amplification unit 150.

The underwater equipment 100 includes at least two first pump lasers and two second pump lasers, each of the first pump lasers provides 25% of energy for the optical amplification unit 150, and each of the second pump lasers provides 25% of energy for the optical amplification unit 150.

In some embodiments, only one second pump laser of the multiple second pump lasers of the underwater equipment 100 is connected with the backup pump laser 102. By providing the backup pump laser 102 to only one conventional pump laser 101 of the underwater equipment 100, reduced pump power due to aging may be compensated, additional pump power may be provided in case of aging caused by the losses of the submarine cables and other components of the underwater fiber communication system, and cost can also be reduced.

As shown in FIG. 2, for example, the underwater equipment 100 adopts a single optical fiber pair 2×2 protection mode, that is, outputs of two conventional pump laser are coupled by one coupler and then outputted to two paths of optical amplification units of one optical fiber pair in accordance with a ratio of 50%: 50%. One backup pump laser 102 is added on the basis of the two conventional pump lasers, and the backup pump laser and the conventional pump lasers are optically coupled through a polarization beam combiner (PBC).

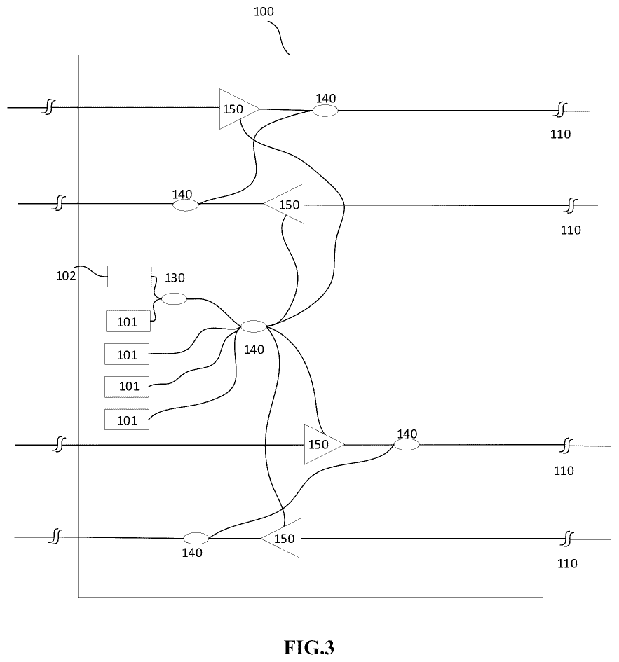

As another example, the underwater equipment 100 may adopt a single optical fiber pair 4×4 protection mode, in the 4×4 pump optical paths adopted by the underwater equipment 100, only one backup pump laser 102 is added. FIG. 3 shows a second structural schematic diagram of an underwater equipment 100, which has similar implementation principle, and thus will not be repeated herein.

A 4×8 pump lasers that may be used by the underwater equipment 100 have similar implementation principle, and thus will not be repeated herein.

In the underwater equipment 100 provided according to some embodiments of the present application, a coupling loopback path of the COTDR backward scattered optical signal is established between the uplink and downlink optical fiber links of the same optical fiber pair, and the first optical fiber coupler and the second optical fiber coupler are cross-connected to input pump lights to the optical amplification units. In addition, each first-stage 2×2 optical fiber coupler couples pump lights from two pump lasers and outputs two paths of first-stage sub-pump light. Each second-stage 2×2 optical fiber coupler couples two paths of first-stage sub-pump lights from different first-stage 2×2 optical fiber couplers and outputs two paths of second-stage sub-pump lights. Each path of second-stage sub-pump light provides energy for one EDFA module, and pump laser outputted by each pump laser may provide 25% of energy for each of the four EDFA modules, and each EDFA module will receive 25% of the pump laser energy from each of the four pump lasers. The first optical fiber coupler and the second optical fiber coupler are cross-connected with each other to form a complete closed loop. With structural symmetry, it may be extended indefinitely in theory, and may be applied to an underwater fiber communication system with more than three optical fiber pairs.

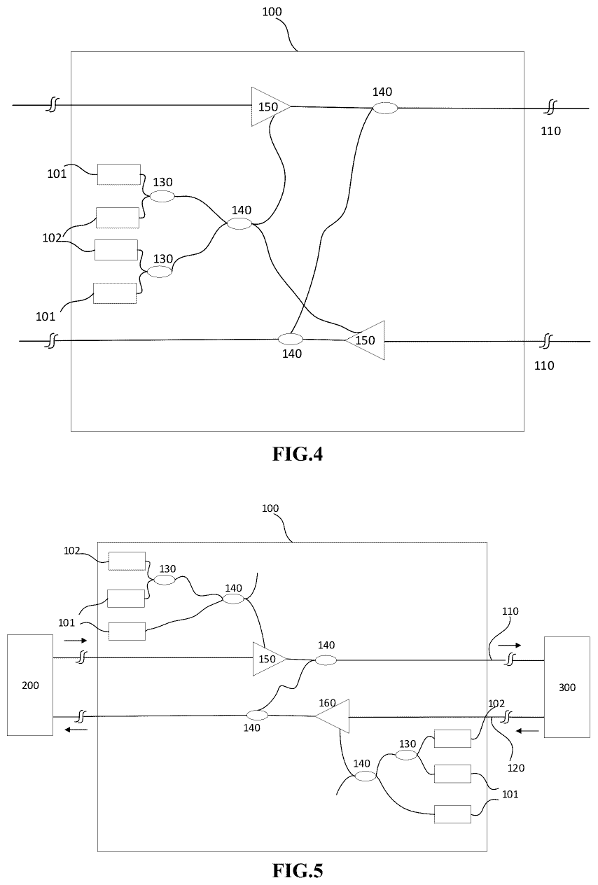

In some embodiments, each conventional pump laser is provided with a backup pump laser, as shown in FIG. 4, for example, the underwater equipment 100 adopts a single optical fiber pair 2×2 protection mode, that is, outputs of two conventional pump laser are coupled by an optical fiber coupler and then outputted to two optical amplification units of one optical fiber pair in accordance with a ratio of 50%: 50%. The conventional pump laser and the backup pump laser are coupled through a polarization beam combiner or an optical switch.

The range and granularity for adjusting performance of the entire underwater fiber communication system are improved by providing a backup pump laser to each conventional pump laser of each underwater equipment in the entire line.

In some embodiments, the optical device 130 is a polarization beam combiner or an optical switch. The backup pump laser 102 and the conventional pump laser 101 may be optically coupled via a polarization beam combiner (PBC). Further, the backup pump laser 102 and/or the conventional pump laser 101 may be controlled with an optical switch.

The backup pump laser 102 and the conventional pump laser 101 are combined via a polarization beam combiner or selectively on or off through an optical switch. The backup pump laser 102 is normally closed and is started when necessary. With the conventional pump laser 101 and the backup pump laser 102 work together, the pump output power can meet the output requirements, or the backup pump laser 102 is started to provide additional pump power in case of aging due to losses of the submarine cable and other component of the underwater fiber communication system, and thus the service life of the underwater fiber communication system is extended.

In some embodiments, the backup pump laser 102 may be a pump laser with the same output power and reliability level as the normally working conventional pump laser 101. By choosing a device of the same model as the online working pump laser, it may be achieved that the online working pump laser fails or the output power drops below the system criteria.

In some embodiments, since the backup pump laser 102 is only used to compensate the power reduced due to aging of the underwater equipment, the submarine cable optical fiber or other optical device of the underwater fiber communication system, the backup pump laser 102 may be a pump laser with the same reliability level as the normally working conventional pump laser 101 but with a lower output power. By using a pump laser of a model with an output power lower than the online working conventional pump laser, cost may be reduced.

Since the backup pump laser 102 is only started in the middle and late life span of the system, its cumulative operating time is not long, and the reliability requirement is not high. In some embodiments, the backup pump laser 102 may be a pump laser with a lower reliability level than the normally working conventional pump laser 101. For example, the backup pump laser may be a pump laser of a land cable level that is not used in a submarine cable repeater, to reduce cost. In addition, as device failure is a probabilistic event, the probability of partial devices failure may be compensated or reduced by providing more devices with common reliability level.

It should be noted that if the working current of the pump laser is too large, the probability of failure of the pump laser would be increased, so it is desired to control the drive current of the backup pump laser 102. In some embodiments, some of the backup pump lasers 102 of the underwater equipment 100 may be selectively turned on based on theoretical analysis or measured results of the optimal performance point of the entire submarine cable communication system. Wherein, the working current of each backup pump laser 102 in operation is kept constant.

In some embodiments, the drive currents of the backup pump lasers 102 that are turned on may be adjusted according to the theoretical analysis or the measured result of the optimal performance point of the entire submarine cable communication system, such that the underwater equipment 100 operates at the optimal performance state.

It should be noted that the underwater equipment 100 according to the embodiment of this application may be, for example, an optical repeater (RPT). Since there is signal loss in the cable during long-distance communication transmission, optical repeaters with signal relay amplification function are generally provided in the submarine cable at every certain distance, such as 50 km, 70 km, 100 km, etc., such that the signal may be transmitted over a long distance. During the establishment of the underwater fiber communication system, the underwater equipment 100 is usually directly set on the cable and coiled together to be lowered into the water with the cable.

With a backup pump laser 102 being added to the optical repeater, the output power of the conventional pump laser reduced due to aging is compensated. By improving the aging condition of the pump laser, the output power of the optical repeater meets the working requirements, the noise coefficient of the optical repeater is kept stable, and the transmission performance is kept stable. The added backup pump laser is not only used to compensate the reduced pump power due to aging, but also to provide additional pump power in case of aging caused by losses of the submarine cable and other component of the underwater fiber communication system, and to make the transmission performance of the underwater fiber communication system stable.

As shown in FIG. 5, an underwater fiber communication system is provided according to some embodiments of the present application. The underwater fiber communication system includes a first station 200, a second station 300 and the underwater equipment 100 according to the above embodiments.

The underwater equipment 100 is coupled to an uplink between the first station 200 and the second station 300, and/or the underwater equipment 100 is coupled to a downlink between the first station 200 and the second station 300.

The first station 200 is configured to send a first data optical signal to the optical fiber of the underwater equipment 100 coupled to the uplink; and the underwater equipment 100 coupled to the uplink is configured to amplify the first data optical signal and send the amplified first data optical signal to the second station 300; or the second station 300 is configured to send a second data optical signal to the optical fiber of the underwater equipment 100 coupled to the downlink; and the underwater equipment 100 coupled to the downlink is configured to amplify the second data optical signal and send the amplified second data optical signal to the first station 200.

The first station 200 and/or the second station 300 determine whether a system aging occurs according to change in an optical signal noise ratio of a service optical signal at a receiving end; the first station 200 and/or the second station 300 predict a system aging trend by monitoring a change trend of the optical signal noise ratio in real time or periodically detecting and comparing change in the optical signal noise ratio.

In some embodiments, the first station 200 is also configured to send a detection optical signal to the underwater equipment 100 through the optical fiber 110 on uplink. The underwater equipment 100 receives a first reflected optical signal from the optical fiber coupler 140, and sends the first reflected optical signal towards the second station 300. The first reflected optical signal is obtained by backward rayleigh scattering the amplified detection optical signal. The first station 200 is also configured to receive the second reflected optical signal, and determine whether the conventional pump laser 101 or the underwater fiber communication system has a fault or is aging based on the second reflected optical signal.

In some embodiments, the second station 300 is also configured to send a detection optical signal to the underwater equipment 100 through the optical fiber 120 on downlink, the underwater device 100 receives the second reflected optical signal from the optical fiber coupler 140, and sends the second reflected optical signal towards the first station 200. The second reflected light signal is obtained from the amplified detection light signal after backward rayleigh scattering. The second station 300 is also configured to receive the first reflected light signal, and determine whether the conventional pump laser 101 or the underwater fiber communication system has a failure or is aging according to the first reflected light signal.

In this embodiment, the number of the backup pump lasers of the underwater equipment 100 in the underwater fiber communication system is greater than or equal to 1, and is less than or equal to n, where n is the number of the conventional pump lasers. For example, each conventional pump laser 101 may be connected with a backup pump laser 102, or only one conventional pump laser 101 is connected with a backup pumped laser 102 (the entire underwater equipment includes only one backup pump laser 102). The backup pump laser 102 may be provided for a certain proportion of the conventional pump lasers based on actual requirements.

The underwater fiber communication system in this application includes the underwater equipment 100 provided according to at least one of the above embodiments (i.e. the underwater equipment provided with a backup pump laser). For ease of distinction, the conventionally-designed underwater equipment is referred to as the first underwater equipment, and the underwater equipment provided according to this application is referred to as the second underwater equipment. The number of the second underwater equipment of the underwater fiber communication system is greater than or equal to 1, and is less than or equal to m, where m is the total number of the underwater equipment. For example, all the underwater equipments in the underwater fiber communication system are the second underwater equipment; alternatively, the second underwater equipment may be provided in a certain proportion or periodically through device reliability and system performance evaluation.

The backup pump laser 102 in the underwater equipment 100 of the underwater fiber communication system according to this application is in a closed state before receiving the first and/or second instruction, and is started upon receiving the first and/or second instruction. The first and second instructions may refer to those mentioned in the above embodiments, which are not described here.

It should be noted that the optical amplification unit has the characteristic of output saturation effect. When an input optical power of the amplifier reaches a threshold value, the input optical power increases or decreases within a certain range, thus an output optical power will remain substantially unchanged, and the corresponding amplifier gain will decrease or increase by substantially the same amount as the change of the input optical power. Whether the conventional pump laser has a fault or is aging may be determined based on the change amount of the optical power of the backward rayleigh scattered light, which facilitates starting the backup pump laser in time and compensating the reduced output power of the conventional pump laser due to aging.

From the above technical solutions, an underwater equipment and a communication system are provided according to some embodiments of the present application. The underwater equipment includes an optical fiber, a conventional pump laser and a backup pump laser. The conventional pump laser is configured to provide pump lights to an optical amplification unit located at the optical fiber. The backup pump laser is configured to perform output power compensation when an output power of the conventional pump laser is less than a target output power, and the backup pump laser is further configured to perform output power compensation when an aging value of the underwater equipment is greater than a first threshold value or when an aging value of a line connected to the underwater equipment or an optical device of the underwater equipment is greater than a second threshold value. According to the present application, by providing the underwater equipment with a backup pump laser, pump output power of the underwater equipment may be compensated by starting the backup pump laser when the conventional pump laser is aging, or the backup pump laser may be timely started to compensate line losses due to aging of the submarine cable and to compensate RPT output power losses due to aging of other optical device, and thus the service life of the submarine cable communication system is improved.

The embodiments provided in this application may be referred to with each other for similar parts. The embodiments provided above are only some examples under the general concept of this application and do not constitute limitations to the protection scope of this application. For persons skilled in the art, any other implementations that are extended based on this application without creative labor shall fall within the protection scope of this application.

What is claimed is:

1. An underwater equipment, comprising an optical fiber, a conventional pump laser and a backup pump laser, wherein
the conventional pump laser is configured to provide pump light to an optical amplification unit located at the optical fiber;
the conventional pump laser and the backup pump laser are coupled to an input port of an optical device of the optical fiber, and an output port of the optical device is coupled to the optical fiber;
the backup pump laser is configured to, when an output power of the conventional pump laser is less than a target output power, perform output power compensation, wherein a compensated output power is greater than or equals to an output power lost by the conventional pump laser in an aging state, and the backup pump laser is further configured to, when an aging value of the underwater equipment is greater than a first threshold value or when an aging value of a line connected to the underwater equipment or an optical device of the underwater equipment is greater than a second threshold value, perform output power compensation;
the backup pump laser is configured to be in a closed state before receiving a first instruction, and to start and output pump light upon receiving the first instruction, wherein the first instruction is a control instruction that is sent when the output power of the conventional pump laser is less than the target output power; and
the backup pump laser is further configured to be in the closed state before receiving a second instruction, and to start and output pump light upon receiving the second instruction, wherein the second instruction is a control instruction that is sent when the aging value of the underwater equipment is greater than the threshold value, or the second instruction is a control instruction that is sent when the aging value of the line connected to the underwater equipment or the optical device of the underwater equipment is greater than the second threshold value, wherein the aging value of the underwater equipment is obtained based on a bit error rate, an optical signal noise ratio and a coherent optical time domain reflection detection of the underwater equipment.

2. The underwater equipment according to claim 1, wherein a quantity of the backup pump laser is greater than or equal to 1, and is less than or equal to n, where n equals to a quantity of the conventional pump lasers.

3. The underwater equipment according to claim 2, wherein the conventional pump laser comprises a first pump laser and a second pump laser;
the second pump laser and the backup pump laser are coupled to the input port of the optical device of the optical fiber, and the output port of the optical device is coupled to the optical fiber;
the first pump laser is coupled to the optical fiber through an optical fiber coupler; an input port of the optical fiber coupler is connected with the output port of the optical device and the first pump laser, and an output port of the optical fiber coupler is connected with the optical amplification unit.

4. The underwater equipment according to claim 3, wherein the underwater equipment comprises at least one first pump laser and one second pump laser, each first pump laser provides 50% of energy for the optical amplification unit, and the second pump laser provides 50% of energy for the optical amplification unit; or
the underwater equipment comprises at least three first pump lasers and one second pump laser, each first pump laser provides 25% of energy for the optical amplification unit, and the second pump laser provides 25% of energy for the optical amplification unit.

5. The underwater equipment according to claim 3, wherein the conventional pump lasers of the underwater equipment comprises only one second pump laser that is connected with the backup pump laser.

6. The underwater equipment according to claim 1, wherein the optical device is a polarization beam combiner or an optical switch.

7. The underwater equipment according to claim 1, wherein each conventional pump laser is provided with a backup pump laser, and the conventional pump laser and the backup pump laser are coupled via a polarization beam combiner or an optical switch.

8. The underwater equipment according to claim 1, wherein the underwater equipment is an optical repeater.

9. An underwater fiber communication system, comprising a first station, a second station and the underwater equipment according to claim 1, wherein the underwater equipment is coupled to an uplink between the first station and the second station, and/or the underwater equipment is coupled to a downlink between the first station and the second station;
the first station is configured to send a first data optical signal to the optical fiber of the underwater equipment coupled to the uplink; and
the underwater equipment coupled to the uplink is configured to amplify the first data optical signal and send an amplified first data optical signal to the second station;
or
the second station is configured to send a second data optical signal to the optical fiber of the underwater equipment coupled to the downlink; and
the underwater equipment coupled to the downlink is configured to amplify the second data optical signal and send an amplified second data optical signal to the first station;
wherein the first station and/or the second station determine whether a system aging occurs according to change in an optical signal noise ratio of a service optical signal at a receiving end; the first station and/or the second station predict a system aging trend by monitoring a change trend of the optical signal noise ratio in real time or periodically detecting and comparing changes in the optical signal noise ratio.

10. The underwater fiber communication system according to claim 9, wherein the underwater fiber communication system determines an aging degree of the underwater fiber communication system based on detecting in real time a bit error rate of a system service performance or monitoring data of a terminal station OTDR/COTDR.
